(19) United States
(12) Patent Application Publication
(10) Pub. No.: US 2026/0153375 A1
(43) Pub. Date: Jun. 4, 2026

(54) WATER LEVEL SENSOR AND ICE MAKER COMPRISING IT

(71) Applicant: BLUENIX Co., Ltd., Ansan-si (KR)

(72) Inventors: Ho Jin HAN, Gimpo-si (KR); Seung Jin SHIN, Ansan-si (KR)

(73) Assignee: BLUENIX Co., Ltd., Ansan-si (KR)

(21) Appl. No.: 19/178,709

(22) Filed: Apr. 14, 2025

(30) Foreign Application Priority Data
Oct. 18, 2024 (KR) 10-2024-0143237

(51) Int. Cl. G01F 23/58; F25C 1/25

(52) U.S. Cl. CPC G01F 23/58; F25C 1/25; F25C 2700/04

(57) ABSTRACT

The present disclosure provides a water level sensor and an ice maker including the same, which may control a size of ice supplied to a user by changing high and low water level sensing positions of the water level sensor, and which are easy to be maintained. In an embodiment, the water level sensor includes a main body portion provided in an ice-making water storage tank, and having a first surface exposed in a height direction; a sensor unit provided in the main body portion, and including a plurality of float sensors sensing a water level of ice-making water in the ice-making water storage tank; and a sensing position adjustment unit coupled to the plurality of float sensors, and raising or lowering at least one float sensor, among the plurality of float sensors, in the height direction, to change water level sensing positions of the plurality of float sensors.

### CROSS-REFERENCE TO RELATED APPLICATION(S)

This application claims benefit of priority to Korean Patent Application No. 10-2024-0143237 filed on Oct. 18, 2024 in the Korean Intellectual Property Office, the disclosure of which is incorporated herein by reference in its entirety.

### BACKGROUND

### 1. Field

The present disclosure relates to a water level sensor and an ice maker including the same, which may control a size of ice supplied to a user by changing high and low water level sensing positions of the water level sensor, and which are easy to maintain.

### 2. Description of Related Art

An ice maker may be a device that freezes water to produce ice having a certain size and shape and supplies the same to a user, and may be widely used for general household use as well as commercial use.

Performance of the ice maker may affect quality and a production speed of the ice, and in general, the performance of the ice maker may mainly depend on appropriate supply and management of ice-making water. That is, ice may be formed in the ice maker according to an amount of ice-making water supplied, and when ice-making water of an appropriate level is not provided, problems may occur in terms of a size or quality of ice. In particular, commercial ice makers sometimes have problems in meeting needs of a user requiring ice of a consistent size. Recently, technical improvements capable of producing ice having a desired size for the user are required.

Conventional ice makers store ice-making water in a storage tank, and repeat a process of flowing the ice-making water over a cold plate to produce ice having a desired thickness or size. In order to repeat the process, a certain amount of ice-making water should be supplied to the cold plate, and in order to control an amount of ice-making water supplied, a water level sensor in the storage tank may be used. For example, the ice makers control a size by producing ice as much as an amount of ice-making water supplied from a point in time at which the water level sensor senses that the ice-making water in the storage tank has reached a high level until a point in time at which the water level sensor senses that the ice-making water in the storage tank has reached a low level.

Meanwhile, since the conventional ice makers may only sense the preset high and low water levels, in a state in which the water level sensor is fixed, there may be a disadvantage in that an amount of ice-making water supplied to the cold plate cannot be changed. However, since the amount of ice-making water supplied may be directly related to the size of the ice, in order to provide various sizes of ice, it is necessary to adjust a sensing range of the ice-making water level sensed in the storage tank in various manners.

### SUMMARY

An aspect of the present disclosure is to provide a water level sensor and an ice maker including the same, which may control a size of ice supplied to a user by changing high and low water level sensing positions of the water level sensor, and which are easy to be maintained.

In order to achieve the purpose, the present disclosure provides a water level sensor and an ice maker including the same, as follows:

In an embodiment, the present disclosure provides a water level sensor including a main body portion provided in an ice-making water storage tank, and having a first surface exposed in a height direction; a sensor unit provided in the main body portion, and including a plurality of float sensors sensing a water level of ice-making water in the ice-making water storage tank; and a sensing position adjustment unit coupled to the plurality of float sensors, and raising or lowering at least one float sensor, among the plurality of float sensors, in the height direction, to change water level sensing positions of the plurality of float sensors.

In an embodiment, the plurality of float sensors may include a first float sensor and a second float sensor, spaced apart from each other, and the first float sensor may be provided in a higher position in the height direction than the second float sensor, based on a ground.

In an embodiment, the first float sensor may include a first sensor body extending in the height direction, and a first floater connected to the first sensor body and provided to float according to the water level of the ice-making water, and may sense a high water level according to a change in position of the first floater, and the second float sensor may include a second sensor body extending in the height direction, and a second floater connected to the second sensor body and provided to float according to the water level of the ice-making water, and may sense a low water level according to a change in position of the second floater.

In an embodiment, in the height direction, a length of the first sensor body may be shorter than a length of the second sensor body.

In an embodiment, the sensing position adjustment unit may include a first position adjustment member having an insertion hole formed therein, such that the first float sensor is inserted, and raising or lowering the first float sensor in the height direction; and a second position adjustment member having an insertion hole formed therein, such that the first float sensor is inserted, and raising or lowering the second float sensor in the height direction.

In an embodiment, the first float sensor and the second float sensor may have screw threads formed on outer side surfaces, the first position adjustment member and the second position adjustment member may have female screws formed on inner side surfaces of the insertion holes to be screw-coupled to the screw threads, the first float sensor may be raised or lowered in the height direction by rotation of the first position adjustment member, and the second float sensor may be raised or lowered in the height direction by rotation of the second position adjustment member.

In an embodiment, the first position adjustment member and the second position adjustment member may have knobs formed on outer side surfaces such that a user rotates the knobs by hand.

In an embodiment, the first float sensor and the second float sensor may further include stoppers respectively provided on one ends and having a diameter, greater than a diameter of each of the insertion holes; and catch members respectively provided on the other ends and preventing each of the floaters from being detached.

In an embodiment, the water level sensor may further include a fixing member respectively fixing the first position adjustment member and the second position adjustment member in an internal space of the main body portion, wherein the fixing member may include a first support member protruding inwardly from the main body portion, and seating and supporting the first position adjustment member; and a second support member protruding inwardly from the main body portion, spaced apart from the first support member in a length direction of the main body portion, and seating and supporting the second position adjustment member.

In an embodiment, in the main body portion, a knob hole may be formed on one surface such that at least a portion of the knobs of each of the first position adjustment member and the second position adjustment member are inserted and protruded outwardly of the main body portion.

In an embodiment, the main body portion may include a first housing and a second housing, inserted into and coupled to each other, in a width direction, the first housing may include insertion members respectively formed on both ends in the length direction and extending in the width direction, and the second housing may include coupling members formed respectively formed on both ends in the length direction, and having holes formed such that the insertion members are inserted.

In an embodiment, the main body portion may further include a first cover member formed on a second surface in the height direction to protrude in the height direction, and provided to surround the first float sensor, and a second cover member provided to surround the second float sensor, and wherein a length of the first cover member in the height direction may be longer than a length of the second cover member in the height direction.

In an embodiment, the water level sensor may further include a temperature sensor installed to pass through one surface of the main body portion and sensing a temperature of the ice-making water.

In an embodiment, the present disclosure provides an ice maker including an ice-making water storage tank receiving and storing ice-making water from a water supply source, a cooling unit receiving the ice-making water stored in the ice-making water storage tank, and heat exchanging with a refrigerant to generate ice, and the above-described water level sensor installed in the ice-making water storage tank and sensing a water level of the stored ice-making water.

### BRIEF DESCRIPTION OF DRAWINGS

The other aspects, features, and advantages of the present disclosure will be more clearly understood from the following detailed description, taken in conjunction with the accompanying drawings, in which:

FIG. 1 is a schematic perspective view of a water level sensor according to an embodiment of the present disclosure, as viewed from one side.

FIG. 2 is an exploded view of a water level sensor according to an embodiment of the present disclosure.

FIGS. 3 and 4 are schematic perspective views illustrating a portion of a water level sensor according to an embodiment of the present disclosure.

FIG. 5 is an exploded view of a sensor unit according to an embodiment of the present disclosure.

FIGS. 6 and 7 are views illustrating a usage state of an ice maker to which a water level sensor according to an embodiment of the present disclosure is applied.

### DETAILED DESCRIPTION

Hereinafter, specific embodiments of the present disclosure will be described with reference to the attached drawings. However, the idea of the present disclosure is not limited to presented embodiments, and those skilled in the art who understand the idea of the present disclosure may easily propose other degenerative inventions or other embodiments included within the scope of the idea of the present disclosure by adding, changing, or deleting other components within the scope of the same idea, but this is also included within the scope of the idea of the present disclosure.

In addition, throughout the specification, the term “connected” to another component means not only a case in which these components are “directly connected” but also a case in which they are “indirectly connected” with another component in between. In addition, “including” a component means that other components may be included rather than excluding other components, unless specifically stated otherwise.

In addition, components that have the same function within the scope of the same idea illustrated in the drawings of each embodiment will be described using the same reference numerals.

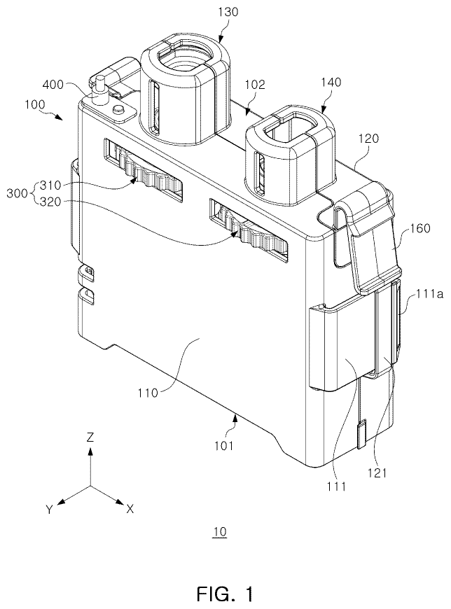

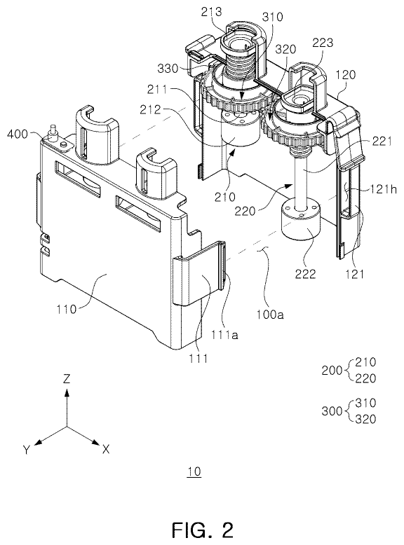

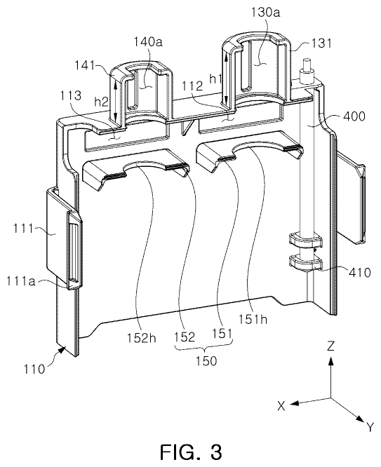

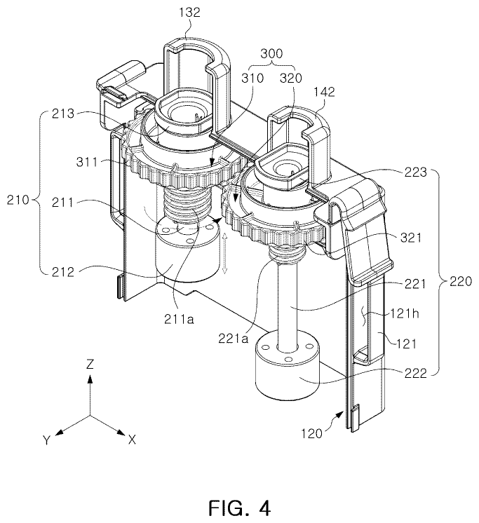

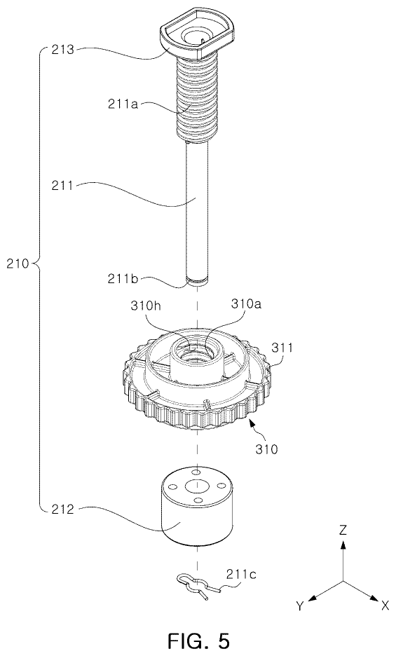

FIGS. 1 to 5 are views illustrating a water level sensor 10 according to an embodiment of the present disclosure. More specifically, FIG. 1 is a schematic perspective view of a water level sensor 10 according to an embodiment of the present disclosure, as viewed from one side, FIG. 2 is an exploded view of a water level sensor 10 according to an embodiment of the present disclosure, FIGS. 3 and 4 are schematic perspective views illustrating a portion of a water level sensor 10 according to an embodiment of the present disclosure, and FIG. 5 is an exploded view of a sensor unit 200 according to an embodiment of the present disclosure. Hereinafter, a water level sensor 10 according to an embodiment of the present disclosure will be described with reference to FIGS. 1 to 5.

In this specification, a height direction may mean a Z direction in the drawings and a direction, perpendicular to a ground, a length direction may mean an X-direction in the drawings and a direction in which first and second float sensors to be described later are arranged, and a width direction may mean a Y-direction in the drawings and a direction, perpendicular to the height direction and the length direction.

A water level sensor 10 according to an embodiment of the present disclosure may include a main body portion 100, a sensor unit 200, and a sensing position adjustment unit 300. Although not illustrated in the drawings, a water level sensor 10 according to an embodiment of the present disclosure may be provided in an ice-making water storage tank (not illustrated) in which ice-making water is stored. The main body portion 100 may include a first housing 110 and a second housing 120, which may be inserted into and coupled to each other, in the width direction. In this case, to be combined to form a tetragonal pillar shape, the first housing 110 and the second housing 120 may have shapes corresponding thereto.

Furthermore, the first housing 110 may include an insertion member 111 respectively formed on both ends in the length direction and extending in the width direction, and the second housing 120 may include a coupling member 121 respectively formed on both ends in the length direction and having a hole 121a formed therein such that the insertion member 111 is inserted. After being inserted into the coupling member 121, a catch 111a may be formed on one end of the insertion member 111 such that the insertion member 111 is not removed. Therefore, the first housing 110 and the second housing 120 may be easily detached as the insertion member 111 is inserted into the hole 121a of the coupling member 121 in the width direction, thereby facilitating maintenance.

An accommodation space 100a may be provided in the main body portion 100 such that the sensor unit 200 and the sensing position adjustment unit 300 may be installed therein. The main body portion 100 may have a first surface 101 exposed in the height direction, and ice-making water accommodated in the ice-making water storage tank (not illustrated) may be introduced through the first surface 101. Therefore, the water level sensor 10 may accommodate ice-making water in the accommodation space 100a on a water level, equal or similar to a water level of the ice-making water accommodated in the ice-making water storage tank (not illustrated). The main body portion 100 may further include a cover member (130 and 140) formed to protrude in the height direction on a second surface 102 in the height direction. A first cover member 130 and a second cover member 140 may be spaced apart in the length direction, and may be provided to surround a plurality of float sensors 210 and 220 to be described later. More specifically, the first cover member 130 may include a first member 131 of the first housing 110 and a second member 132 of the second housing 120 coupled to the first member 131, and a first raising/lowering space 130a may be provided inwardly such that a first float sensor 210 to be described later may be raised/lowered in the height direction. Likewise, the second cover member 140 may include a third member 141 of the first housing 110 and a fourth member 142 of the second housing 120 coupled to the third member 141, and a second raising/lowering space 140a may be provided inwardly such that a second float sensor 220 to be described later may be raised/lowered in the height direction. In this case, a length h1 of the first cover member 130 in the height direction may be longer than a length h2 of the second cover member 140 in the height direction. As a result, the first float sensor 210 sensing a high water level may be raised or lowered in a higher direction.

The sensor unit 200 may be provided in the main body portion 100, and may include the plurality of float sensors 210 and 220 sensing a water level of ice-making water in the ice-making water storage tank (not illustrated), and the plurality of float sensors 210 and 220 may include the first float sensor 210 and the second float sensor 220, spaced apart from each other. The first float sensor 210 may include a first sensor body 211 extending in the height direction, and a first floater 212 connected to the first sensor body 211 and provided to float according to the water level of the ice-making water, and the second float sensor 220 may include a second sensor body 221 extending in the height direction, and a second floater 222 connected to the second sensor body 221 and provided to float according to the water level of the ice-making water.

The first float sensor 210 may be provided in a higher position in the height direction than the second float sensor 220, based on the ground. For example, the first sensor body 211 may be located in a position in which a lowermost end in the height direction may be higher than a lowermost end of the second sensor body 221 in the height direction. In this case, in the height direction, a length of the first sensor body 211 may be shorter than a length of the second sensor body 221. Therefore, the first float sensor 210 may sense a high water level in the ice-making water storage tank (not illustrated) according to a change in position of the first floater 212, and the second float sensor 220 may sense a low water level in the ice-making water storage tank (not illustrated) according to a change in position of the second floater 222.

Furthermore, the first float sensor 210 and the second float sensor 220 may have screw threads 211a and 221a formed on outsides of the sensor bodies 211 and 221, thereby being screw coupled to the sensing position adjustment unit 300 to be described later. In addition, the first float sensor 210 and the second float sensor 220 may have a catch groove 211b (not illustrated) formed on the other end of the sensor body (211 and 221), and a catch member (211c and 221c) may be installed in the catch groove 211b (not illustrated). The first floating body 212 may be provided to be raised or lowered from an upper end of a first catch member 211c without being separated from the first sensor body 211 by gravity, and may be provided on a high water level sensing position for sensing a high water level. Likewise, the second floating body 222 may be provided to be raised or lowered from an upper end of a second catch member 221c without being separated from the second sensor body 221, and may be provided at a low water level sensing position for sensing a low water level.

The sensing position adjustment unit 300 may be coupled to the plurality of float sensors 210 and 220, and may raise and lower at least one of the plurality of float sensors 210 and 220 in the height direction. Therefore, a water level sensor 10 according to an embodiment of the present disclosure may change a water level sensing position sensed by the plurality of float sensors 210 and 220. More specifically, the sensing position adjustment unit 300 may include a first position adjustment member 310 coupled to the first float sensor 210 and a second position adjustment member 320 coupled to the second float sensor 220. More specifically, as illustrated in FIG. 5, the first position adjustment member 310 may have an insertion hole 310h formed inwardly such that the first float sensor 210 is inserted therein, and a female screw 310a may be formed on an inner side surface of the insertion hole 310h to be screw coupled to the screw thread 211a of the first sensor body 211. In addition, the first position adjustment member 310 may have a knob 311 formed on an outer side surface thereof such that the user may rotate the same by hand. Although, in a water level sensor 10 according to an embodiment of the present disclosure, the first position adjustment member 310 is mainly illustrated with reference to FIG. 5, the second position adjustment member 320 may also have the same configuration. Furthermore, the first sensor body 211 and the second sensor body 221 may further include a stopper (213 and 223) provided on one end and having a size, larger than a diameter of the insertion hole 310h. The stopper (213 and 223) may prevent the first sensor body 211 and the second sensor body 221 from being separated from the position adjustment member (310 and 320), respectively.

In addition, the sensing position adjustment unit 300 may include a fixing rod 330 moving the knob 311 by one space and stopping the same in an adjusted position. The fixing rod 330 may have a structure that return when a position thereof is changed according to rotation of the knob 311 in conjunction with an elastic member, such that when the user operates the adjustment unit 300, the user may know that the knob 311 has moved by one space, and when the user does not operate the adjustment unit 300, the knob 311 may be prevented from rotating. The fixing rod 330 may be disposed outside the first and second position adjustment members 310 and 320 in the main body portion 100. A water level sensor 10 according to an embodiment of the present disclosure may further include a fixing member 150 fixing the sensing position adjustment unit 300. The fixing member 150 may include a first support member 151 and a second support member 152, formed to protrude inwardly of the main body portion 100 to fix the first and second position adjustment members 310 and 320, respectively, and spaced apart in the length direction. The first support member 151 and the second support member 152 may have a support hole (151h and 152h) having a semicircular shape and inwardly formed, respectively, to allow the plurality of float sensors 210 and 220 to be raised or lowered in the height direction. In this case, the first support member 151 and the second support member 152 may be formed in the first housing 110 and the second housing 120, respectively, and may have a plate shape with a circular hole formed in a central portion, as the first housing 110 and the second housing 120 are combined. The first support member 151 and the second support member 152 may be provided spaced apart from an inner upper surface of the main body portion 100 by a length of the position adjustment member (310 and 320) in the height direction, whereby the position adjustment members 310 and 320 are supported by being seated on upper surfaces of the support member 151 and the second support member 152, respectively, in the main body portion 100. Furthermore, the main body portion 100 may have a knob hole (112 and 113) formed on one surface thereof such that at least a portion of the knob (311 and 321) of the first and second position adjustment member (310 and 320) may be inserted therein and protrudes outwardly from the main body portion 100. Therefore, a water level sensor 10 according to an embodiment of the present disclosure may raise and lower at least one of the first and second sensor bodies (211 and 221) by easily rotating the knob (311 and 321) protruding outward from the main body portion 100.

For example, a water level sensor 10 according to an embodiment of the present disclosure may raise and lower each of the screw coupled float sensors 210 and 220 in the height direction by rotating the knob (311 and 321) in a state in which the position adjustment member (310 and 320) is fixed. More specifically, the user may raise and lower the first sensor body 211 by a length formed by the screw thread 211a in the height direction by rotating the first position adjustment member 310, and similarly, the user may raise and lower the second sensor body 221 by a length formed by the screw thread 221a in the height direction by rotating the second position adjustment member 320. Therefore, in a water level sensor 10 according to an embodiment of the present disclosure, the plurality of float sensors 210 and 220 may sense a high water level or a low water level, and a sensing position of the high water level or the low water level that each of the plurality of float sensors 210 and 220 may sense using the sensing position adjustment member 300 without separating the housings 110 and 120 may be changed.

Furthermore, a water level sensor 10 according to an embodiment of the present disclosure may further include a temperature sensor 400 measuring a temperature of ice-making water. The temperature sensor 400 may be installed by extending in the height direction and penetrating the main body portion 100, and may measure the temperature of the ice-making water accommodated in the accommodation space 100a of the main body portion 100. The temperature sensor 400 may be supported by a temperature sensor fixing member 410 provided on one edge of the first housing 110.

In addition, a water level sensor 10 according to an embodiment of the present disclosure may be easily maintained since components are easily separated from each other. For example, in a water level sensor 10 according to an embodiment of the present disclosure, when only the main body portion 100 may be taken out from in the ice-making water storage tank (not illustrated) and disassembled into the first housing 110 and the second housing 120, the float sensors 210 and 220 and the temperature sensor 400 may be easily maintained.

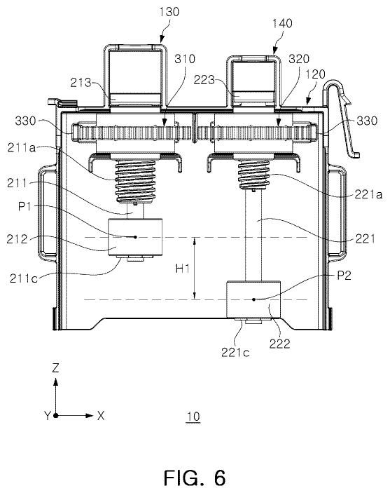

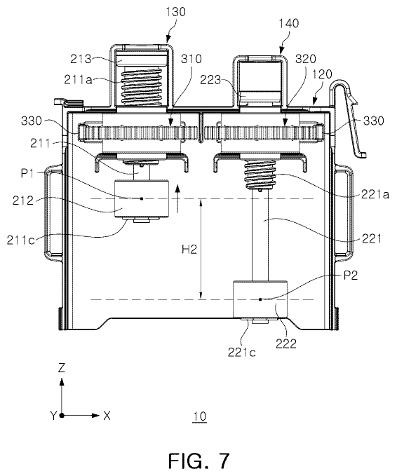

FIGS. 6 and 7 are views illustrating a usage state of an ice maker (not illustrated) to which a water level sensor 10 according to an embodiment of the present disclosure is applied. FIG. 6 is a state before changing a water level sensing position of a water level sensor 10 according to an embodiment of the present disclosure, and FIG. 7 is a state after changing a water level sensing position of a water level sensor 10 according to an embodiment of the present disclosure. The following description will be made with reference to FIGS. 6 and 7.

An ice maker (not illustrated) according to an embodiment of the present disclosure may include an ice-making water storage tank (not illustrated) receiving and storing ice-making water from a water supply source (not illustrated), a cooling unit (not illustrated) receiving the ice-making water stored in the ice-making water storage tank (not illustrated) and heat exchanging with a refrigerant to generate ice, and a water level sensor 10 installed in the ice-making water storage tank (not illustrated) and sensing a water level of the stored ice-making water.

As illustrated in FIG. 6, a water level sensing position of a water level sensor 10 according to an embodiment of the present disclosure, before changing, may include a high water level sensing position P1 and a low water level sensing position P2. A first float sensor 210 may sense a high water level when a first floater 212 is located in the high water level sensing position P1, and a second float sensor 220 may sense a low water level when a second floater 222 is located in the low water level sensing position P2.

When ice-making water is filled up to the high water level sensing position P1, the first float sensor 210 may sense the high water level, and the second float sensor 220 may not sense the low water level, because the second floater 222 is removed from the low water level sensing position P2. When ice is produced by supplying ice-making water in the ice-making water storage tank (not illustrated) to the cooling unit (not illustrated), a water level of the ice-making water may decrease. Therefore, when the water level of the ice-making water decreases sufficiently, the second float sensor 220 may sense the low water level. A user may supply ice-making water to the cooling unit (not illustrated) from a point in time at which the first float sensor 210 senses the high water level until a point in time at which the second float sensor 220 senses the low water level, and may control a size of the ice by blocking the supply to the cooling unit (not illustrated) from a point in time at which the low water level is sensed. For example, an ice maker (not illustrated) according to an embodiment of the present disclosure may supply ice-making water to the cooling unit (not illustrated) in an amount, equal or similar to a difference H1 between the high water level sensing position P1 and the low water level sensing position P2, to produce ice.

As illustrated in FIG. 7, a water level sensor 10 according to an embodiment of the present disclosure may raise and lower a first float sensor 210 by rotating a first position adjustment member 310. Therefore, the high water level sensing position P1 of a water level sensor 10 according to an embodiment of the present disclosure may be raised in the height direction after changing. Therefore, after the high water level sensing position is changed, an ice maker (not illustrated) according to an embodiment of the present disclosure may supply ice-making water to the cooling unit (not illustrated) in an amount, equal or similar to a difference H2 between the changed high water level sensing position P1 and the low water level sensing position P2, to produce ice.

For example, an ice maker (not illustrated) according to an embodiment of the present disclosure may change an amount of ice-making water supplied to a cooling unit (not illustrated) by changing a water level sensing position by applying a water level sensor 10, thereby changing a size of ice produced in the cooling unit (not illustrated). Therefore, ice having a desired size may be provided by a user. Furthermore, since a water level sensor 10 according to an embodiment of the present disclosure may set a difference (H1 and H2) between a high water level sensing position and a low water level sensing position, which may be proportional to a size of ice, to be smaller than a length of a floater (212 and 222) in the height direction, the size of the ice may be adjusted over a wider range, as compared to those using a single float sensor.

According to an embodiment of the present disclosure, a water level sensor and an ice maker including the same, which may control a size of ice supplied to a user by changing high and low water level sensing positions of the water level sensor, and which are easy to be maintained, may be provided.

While example embodiments have been illustrated and described above, it will be apparent to those skilled in the art that modifications and variations could be made without departing from the scope of the present disclosure as defined by the appended claims.

What is claimed is:

1. A water level sensor comprising:
a main body portion provided in an ice-making water storage tank, and having a first surface exposed in a height direction;
a sensor unit provided in the main body portion, and including a plurality of float sensors sensing a water level of ice-making water in the ice-making water storage tank; and
a sensing position adjustment unit coupled to the plurality of float sensors, and raising or lowering at least one float sensor, among the plurality of float sensors, in the height direction, to change water level sensing positions of the plurality of float sensors.

2. The water level sensor of claim 1, wherein the plurality of float sensors include a first float sensor and a second float sensor, spaced apart from each other, and
the first float sensor is provided in a higher position in the height direction than the second float sensor, based on a ground.

3. The water level sensor of claim 2, wherein the first float sensor includes a first sensor body extending in the height direction, and a first floater connected to the first sensor body and provided to float according to the water level of the ice-making water, and senses a high water level according to a change in position of the first floater, and
the second float sensor includes a second sensor body extending in the height direction, and a second floater connected to the second sensor body and provided to float according to the water level of the ice-making water, and senses a low water level according to a change in position of the second floater.

4. The water level sensor of claim 3, wherein, in the height direction, a length of the first sensor body is shorter than a length of the second sensor body.

5. The water level sensor of claim 4, wherein the sensing position adjustment unit includes:
a first position adjustment member having an insertion hole formed therein, such that the first float sensor is inserted, and raising or lowering the first float sensor in the height direction; and
a second position adjustment member having an insertion hole formed therein, such that the first float sensor is inserted, and raising or lowering the second float sensor in the height direction.

6. The water level sensor of claim 5, wherein the first float sensor and the second float sensor have screw threads formed on outer side surfaces,
the first position adjustment member and the second position adjustment member have female screws formed on inner side surfaces of the insertion holes to be screw-coupled to the screw threads,
the first float sensor is raised or lowered in the height direction by rotation of the first position adjustment member, and
the second float sensor is raised or lowered in the height direction by rotation of the second position adjustment member.

7. The water level sensor of claim 6, wherein the first position adjustment member and the second position adjustment member have knobs formed on outer side surfaces such that a user rotates the knobs by hand.

8. The water level sensor of claim 7, wherein the first float sensor and the second float sensor further include:
stoppers respectively provided on one ends and having a diameter, greater than a diameter of each of the insertion holes; and
catch members respectively provided on the other ends and preventing each of the floaters from being detached.

9. The water level sensor of claim 7, further comprising a fixing member respectively fixing the first position adjustment member and the second position adjustment member in an internal space of the main body portion,
wherein the fixing member includes:
a first support member protruding inwardly from the main body portion, and seating and supporting the first position adjustment member; and
a second support member protruding inwardly from the main body portion, spaced apart from the first support member in a length direction of the main body portion, and seating and supporting the second position adjustment member.

10. The water level sensor of claim 9, wherein, in the main body portion, a knob hole is formed on one surface such that at least a portion of the knobs of each of the first position adjustment member and the second position adjustment member are inserted and protruded outwardly of the main body portion.

11. The water level sensor of claim 10, wherein the main body portion includes a first housing and a second housing, inserted into and coupled to each other, in a width direction,
the first housing includes insertion members respectively formed on both ends in the length direction and extending in the width direction, and
the second housing includes coupling members formed respectively formed on both ends in the length direction, and having holes formed such that the insertion members are inserted.

12. The water level sensor of claim 11, wherein the main body portion further includes a first cover member formed on the second surface in the height direction to protrude in the height direction, and provided to surround the first float sensor, and a second cover member provided to surround the second float sensor, and
wherein a length of the first cover member in the height direction is longer than a length of the second cover member in the height direction.

13. The water level sensor of claim 12, further comprising a temperature sensor installed to pass through one surface of the main body portion and sensing a temperature of the ice-making water.

14. An ice maker comprising:
an ice-making water storage tank receiving and storing ice-making water from a water supply source;
a cooling unit receiving the ice-making water stored in the ice-making water storage tank, and heat exchanging with a refrigerant to generate ice; and
the water level sensor according to claim 1, installed in the ice-making water storage tank and sensing a water level of the stored ice-making water.
